(19) United States
(12) Patent Application Publication
(10) Pub. No.: US 2011/0127771 A1
(43) Pub. Date: Jun. 2, 2011

(54) FITTINGS FOR HIGH PRESSURE HYDRAULIC COUPLINGS

(75) Inventor: Giovanni John Panusa, Richmond (CA)

(73) Assignee: MATRIX TECHNOLOGY CONSULTING LTD., Richmond (CA)

(21) Appl. No.: 12/949,986

(22) Filed: Nov. 19, 2010

Related U.S. Application Data
(60) Provisional application No. 61/265,315, filed on Nov. 30, 2009.
(60) Provisional application No. 61/375,615, filed on Aug. 20, 2010.

(51) Int. Cl. F16L 19/00

(52) U.S. Cl. 285/354

(57) ABSTRACT

Hydraulic fittings for use in high pressure hydraulic couplings are provided. The fittings include a body of a hard material such as steel or stainless steel and having an externally threaded portion that terminates in a frusto-conical nose defining a frusto-conical sealing surface, a circumferential groove provided in the sealing surface, and an annular seal received in the groove and comprised of a more malleable material than said hard material, wherein a portion of the annular seal extends beyond the sealing surface such that the annular seal deforms to closely conform to an internal frusto-conical sealing surface of a complementary fitting used in the coupling to provide a fluid seal between the fittings.

### BACKGROUND OF THE INVENTION

1. Field of Invention

The present invention relates generally to hose couplings used in systems for the transfer of hydraulic fluid at a high system pressure, and more particularly to fittings used in such couplings.

2. Description of Related Art

Couplings and fittings used in high pressure hydraulic oil systems (up to 10,000 psi or 1.45 MPa) utilize a male fitting having a frusto-conical nose portion that engages a flared or frusto-conical interior surface defined on a conduit of a female fitting, wherein the conical surfaces of the male fitting and conduit engage in metal to metal contact to form a fluid seal. The term frusto-conical is commonly defined as having the shape of a cone with the top cut off along a plane parallel to the base of the cone. The male-female fitting combination typically produces an axial clamping force through a thread tightening action to engage the conical surfaces against one another. Unless the contacting conical surfaces are perfectly concentric, accurately formed, and free of mechanical defects such as scratches and gouges, leakage may result even if additional clamping force can be derived through further thread tightening. Dimensional changes may occur to the fittings or conduit due to temperature variations, resulting in an imperfect seal and subsequent fluid leakage. Pressure changes in the hydraulic system can also result in dimensional changes to fittings or conduit that could lead to leakage of hydraulic fluid.

Referring to FIGS. 1 and 2, there is shown an example of a high pressure hydraulic coupling known in the art. A prior art male hydraulic fitting for high pressure hydraulic coupling applications is shown by reference number 10. Male fitting 10 typically comprises a unitarily formed body 12 of a hard material, such as steel or stainless steel, that has a central aperture 14 (shown in FIG. 2) extending along the longitudinal axis 16 of body 12. The central aperture functions as a conduit for the hydraulic fluid passing through the coupling. The body 12 also typically includes a hexagonally shaped wrenching portion 18 that permits the fitting 10 to be installed with conventional tools such as sockets or wrenches, and a threaded portion 20 having external threads 22 formed or cut on the exterior surface for connecting to a complementarily threaded female portion of a female fitting, such as exemplified by reference number 30, also made of a hard material. Adjacent the threaded portion 20 is a frusto-conical nose portion 24 having a frusto-conical male sealing surface 26.

Typically, a female hydraulic fitting 30 comprises a unitarily formed body 32 having a central aperture 34 extending along the longitudinal axis 16 of the body 32, and a sleeve portion 36 having a cylindrical internal aperture 37 which includes internal threads 38 that are complementary to the external threads 22 on a complementary male fitting 10. The aperture 37 is concentric with, but larger than, the aperture 34, and the internal shoulder portion between the two apertures (37 and 34) is tapered to define a smooth frusto-conical female sealing surface 40 that is complementary to the male sealing surface 26 of a complementary male fitting.

In some examples of high pressure hydraulic couplings, a male fitting would be connected to a female fitting such that nose portion 24 is received within the sleeve portion 36 and the male sealing surface 26 mates directly upon the female sealing surface 40 to provide a fluid seal between the apertures 14 and 34. In other examples, the female fitting 30 may include a fluid conduit (not shown) such as a hydraulic line received within aperture 34, and the fluid conduit would typically include a flared metal conical portion that defines a smooth frusto-conical shoulder portion of the female fitting, and the interior seal of the flared portion of the conduit would abut with the male sealing surface 26 of the male fitting 10 such that the fluid seal is formed between the male sealing surface and the interior sealing surface of the conduit. In either case, a fluid seal is formed by mating of the exterior conical sealing surface of the male fitting with an interior conical surface associated with the female fitting.

While reference is made herein to male or female fittings for convenience, such references are not entirely applicable to categorize all fittings at all times since some male fitting may also include an internal cavity having internal threads (i.e. a female portion) adapted to receive the externally threaded portion of another male fitting. Such is the case of the illustrated male fitting 10, which includes an internal threaded cavity 27 (shown in FIG. 2) within the wrenching portion 18.

A problem with the prior art high pressure hydraulic couplings is that the male sealing surface and/or the female sealing surface can be deformed, galled, or gouged as a result of heavy torque typically applied during tightening of the fittings (also referred to herein as tightening of the coupling) wherein the male fitting is axially forced into the female fitting when frusto-conical sealing surfaces 26 and 40 are already seated and abutting. Historically, problems with leakage of fluid have been encountered in high pressure fluid systems using such conical conduit fittings, and often the problematic conduit fittings are located on machinery in hard to reach or hard to see places making the repair of the problem an expensive and time consuming proposition. The failure of a coupling costing a few dollars can result in repair costs into the hundreds or even thousands of dollars. Accordingly, there is a need for fittings for use in high pressure hydraulic couplings that provide a better and more reliable fluid seal over the range of operating conditions experienced in the field.

### SUMMARY OF INVENTION

The above shortcomings may be addressed by providing, in accordance with one aspect of the invention, a hydraulic fitting for use in high pressure hydraulic couplings. The fitting includes a body comprised of a hard material, such as steel or stainless steel, and having an externally threaded portion that terminates in a frusto-conical nose portion having a frusto-conical sealing surface; a circumferential groove provided in the sealing surface; and an annular seal received in the groove and comprised of a more malleable material than said hard material, wherein a portion of the annular seal extends beyond the sealing surface such that the annular seal is able to deform upon tightening of the coupling to closely conform to an internal frusto-conical sealing surface of a complementary fitting used in the coupling to provide a fluid-tight seal between the fittings. In some embodiments of the present invention, the annular seal may include a frusto-conical exterior surface that is parallel to the sealing surface of the nose portion.

In some embodiments of the present invention, the annular seal is comprised of a metal or plastic having the following properties: hardness of less than Rockwell R125 (Rockwell F 40); tensile strength less than 10,000 psi; temperature stability such that it is dimensionally stable below 60° C.; corrosion resistance such that it is resistant to corrosion in moist atmosphere, and is resistant to mechanical property changes in sunlight, atmospheric moisture, and hydraulic oil. Preferably, the annular seal is comprised of a plastic having the following properties: hardness in the range of Rockwell R78-R120; tensile strength in the range 8,000 psi-10,000 psi; temperature stability such that it is dimensionally stable below 60° C.; corrosion resistance such that it is resistant to mechanical property changes in sunlight, atmospheric moisture, and hydraulic oil. More preferably, the annular seal is comprised of a plastic having the following properties: hardness in the range of Rockwell R90-R100; tensile strength in the range 9,000 psi-10,000 psi at 23° C.; temperature stability such that it is dimensionally stable below 60° C.; corrosion resistance such that it is resistant to mechanical property changes in sunlight, atmospheric moisture, and hydraulic oil.

In some embodiments, the annular seal may comprise a stable ductile plastic such as an acetal resin plastic, such as polyoxymethylene, commonly known as DELRIN (trademark). In some embodiments, the annular seal may comprise polytetrafluoroethylene, commonly known as TEFLON (trademark). In some embodiments, the annular seal may comprise copper.

In some embodiments, the exterior surface of the annular seal may be raised above the sealing surface of the nose portion by an amount in the range of 0.06 mm to 0.25 mm. The width of the annular seal may vary depending on the size of the fitting, but may typically be in the range 1.5 mm to 10 mm.

In accordance with another aspect of the invention, there is provided a method of establishing a fluid impermeable seal in hose couplings in high pressure hydraulic systems between mating male and female frusto-conical sealing surfaces, composed of a hard material (such as steel or stainless steel), to prevent hydraulic fluid from leaking out of said coupling, the method comprising the steps of: a) providing a circumferential groove in one of said frusto-conical sealing surfaces; and b) providing an annular seal in the groove, the annular seal being comprised of a metal or plastic having the following properties: hardness of less than Rockwell R125 (Rockwell F 40); tensile strength less than 10,000 psi; temperature stability such that it is dimensionally stable below 60° C.; corrosion resistance such that it is resistant to corrosion in moist atmosphere, and is resistant to mechanical property changes in sunlight, atmospheric moisture, and hydraulic oil, wherein a portion of the annular seal extends above said one of said frusto-conical sealing surfaces such that the annular seal is able to deform upon tightening of the coupling to closely conform to the other of said frusto-conical sealing surfaces to provide a fluid-tight seal between said frusto-conical sealing surfaces. In some embodiments, there may be further included the step of providing a frusto-conical exterior surface in the annular seal that is parallel to said one of said frusto-conical sealing surfaces. In some embodiments, the exterior surface of the annular seal may be above said one of said frusto-conical sealing surfaces by an amount in the range 0.06 mm to 0.25 mm.

In some embodiments, the annular seal may comprise an acetal resin plastic, such as polyoxymethylene, commonly known as DELRIN (trademark). In some embodiments of the present invention, the annular seal may comprise polytetrafluoroethylene, commonly known as TEFLON (trademark). In some embodiments of the present invention, the annular seal may comprise copper.

In some embodiments of the present invention, the annular seal may be manufactured by a number of different methods including machining, molding, and thermal spraying of suitable materials. The design of the circumferential groove may vary with the manufacturing method.

Other aspects and features of the present invention will become apparent to those of ordinary skill in the art upon review of the following description of the specific embodiments of the invention in conjunction with the accompanying figures.

### BRIEF DESCRIPTION OF THE DRAWINGS

In drawings which illustrate by way of example only embodiments of the invention:

FIG. 1 is a side view of an example of a prior art high pressure hydraulic coupling comprising of a male fitting coupled to a female fitting, with the female fitting shown in a sectional view;

FIG. 2 is a plan view from the bottom of the male fitting of FIG. 1;

FIG. 3 is a side view of an embodiment of a high pressure hydraulic fitting in accordance with the present invention;

FIG. 4 is a plan view from the bottom of the hydraulic fitting of FIG. 3;

FIG. 5 is a close up side view of the nose portion of the hydraulic fitting in FIG. 3 with a portion thereof shown in sectional view; and

FIG. 6 is a side view of a high pressure hydraulic coupling comprising male hydraulic fitting of FIG. 3 coupled to an exemplified female fitting, with the female fitting shown in a sectional view.

### DETAILED DESCRIPTION

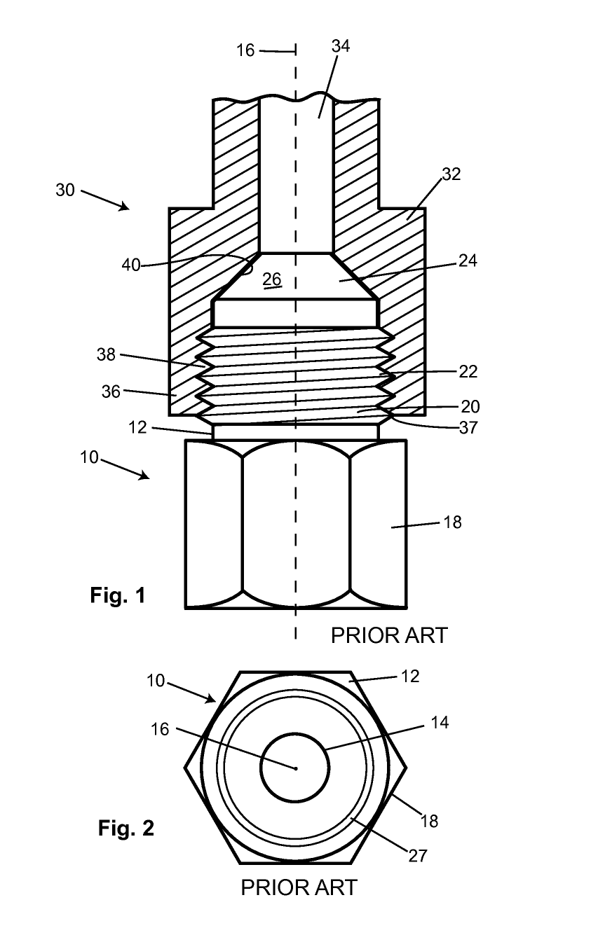

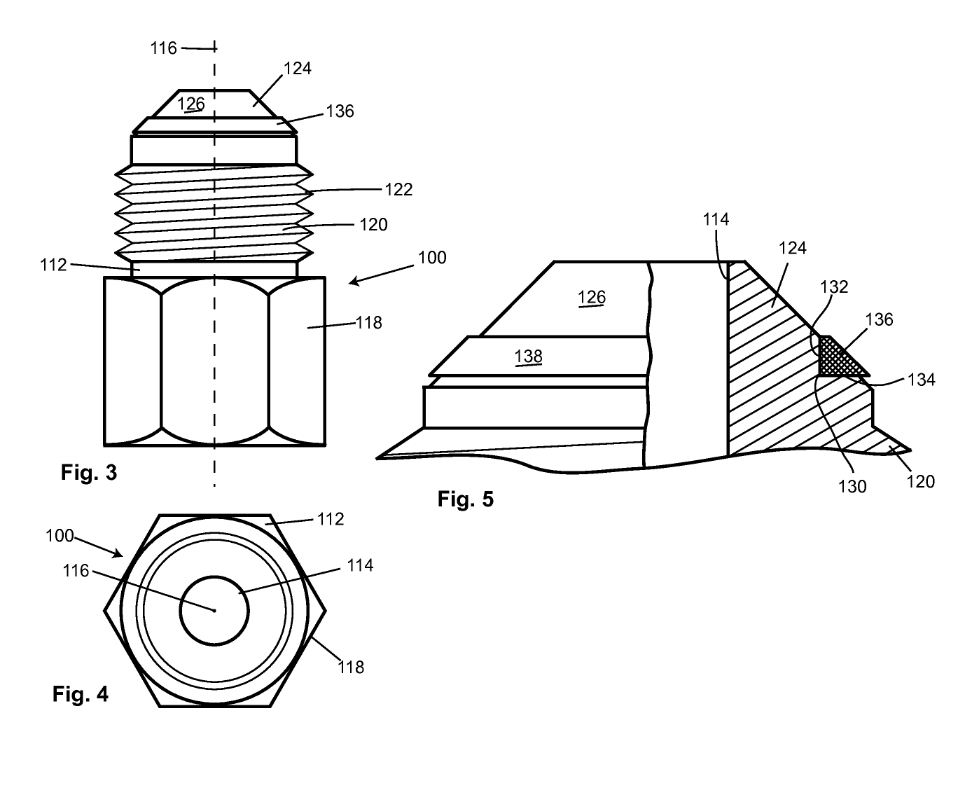

With reference to FIGS. 3 through 5 of the drawings, a high pressure hydraulic fitting in accordance with an embodiment of the present invention is generally indicated by reference numeral 100. Hydraulic fitting 100 comprises a unitarily formed body 112, made from a hard material such as steel or stainless steel, and which has a central aperture 114 extending along the longitudinal axis 116 of body 112. The central aperture 114 functions as a conduit for the hydraulic fluid passing through the coupling. The body 112 also includes a hexagonally shaped wrenching portion 118 that permits the fitting 100 to be installed with conventional tools such as sockets or wrenches, and a threaded portion 120 having external threads 122 formed or cut on the exterior surface for connecting to a complementarily threaded female portion of a complementary fitting, such as exemplified by reference number 30 in FIG. 1.

At the end of the threaded portion 120 is a frusto-conical nose portion 124 having a frusto-conical male (i.e. exterior) sealing surface 126. A circumferential groove 130 is formed into frusto-conical exterior sealing surface 126 of the nose portion 124. Groove 130 is defined by a vertical wall portion 132 and a horizontal wall portion 134 that are perpendicular to each other. However, the groove 130 may define other suitable shapes. Within the groove 130 is provided an annular seal 136, being of complementary shape to the groove 130, and having a frusto-conical exterior surface 138 that extends beyond, but is parallel to, the frusto-conical exterior sealing surface 126 of the nose portion 124 (shown in FIG. 5 but greatly exaggerated for ease of visualization). In width, the annular seal 136 (hence the groove 130) may be 1.5 mm to 10 mm wide, depending on the size of the fitting. It is essential that the exterior surface 138 of the annular seal 136 is raised slightly above the sealing surface 126 for reasons that are explained below herein. Preferably, the exterior surface 138 is raised by an amount in the range 0.06 mm-0.25 mm beyond the sealing surface 126. In some embodiments, the amount by which the exterior surface 138 of the annular seal 136 is raised above the sealing surface 126 may be from a minimum of 0.06 mm, 0.08 mm, 0.10 mm, 0.12 mm, 0.14 mm, 0.16 mm, 0.18 mm, or 0.20 mm to a maximum of 0.12 mm, 0.14 mm, 0.16 mm, 0.18 mm, 0.20 mm, 0.22 mm, 0.24 mm or 0.25 mm, wherein a range may, for example, be selected from any of the foregoing minimum values in combination with any of the foregoing maximum values, or any value lesser than, greater than or in between, for example, 0.10 mm to 0.25 mm, or 0.14 mm to 0.20 mm, or about 0.24 mm.

The annular seal 136 may be comprised of a material that is stable in the temperature range −50° C. to +150° C., has a low coefficient of thermal expansion, remains ductile over the stated temperature range, is creep resistant and has sufficient strength to resist tearing at hydraulic pressures of between 2,000 psi and 10,000 psi. Ductility refers to a material's ability to deform under compressive stress without fracturing.

Preferably, the annular seal 136 comprises a metal or plastic having the following properties: hardness of less than Rockwell R125 (Rockwell F 40); tensile strength less than 10,000 psi; temperature stability such that it is dimensionally stable below 60° C.; corrosion resistance such that it is resistant to corrosion in moist atmosphere, and is resistant to mechanical property changes in sunlight, atmospheric moisture, and hydraulic oil. An example of a suitable metal is copper.

More preferably, the annular seal 136 comprises a plastic having the following properties: hardness in the range of Rockwell R78-R120; tensile strength in the range 8,000 psi-10,000 psi; temperature stability such that it is dimensionally stable below 60° C.; corrosion resistance such that it is resistant to mechanical property changes in sunlight, atmospheric moisture, and hydraulic oil.

Even more preferably, the annular seal 136 comprises a plastic having the following properties: hardness in the range of Rockwell R90-R100; tensile strength in the range 9,000 psi-10,000 psi at 23° C.; temperature stability such that it is dimensionally stable below 60° C.; corrosion resistance such that it is resistant to mechanical property changes in sunlight, atmospheric moisture, and hydraulic oil.

A preferred material for the annular seal 136 includes an acetal resin material, such as polyoxymethylene (marketed under the trademark DELRIN by DuPont). Other plastic materials, such as the tetrafluoroethylene (TFE) family of plastics, for example polytetrafluoroethylene (PTFE) (marketed under the trademark TEFLON by DuPont), also have suitable properties and may be substituted in some embodiments. Accordingly, preferred embodiments of annular seal 136 comprise polyoxymethylene (i.e. DELRIN (trademark)) or polytetrafluoroethylene (i.e. TEFLON (trademark)). However, other metals or plastics having suitable physical properties may be used as the annular seal 136.

In some embodiments, the annular seal may be manufactured by a number of different methods including machining, molding, and thermal spraying of suitable materials. The design of the circumferential groove may vary with the manufacturing method.

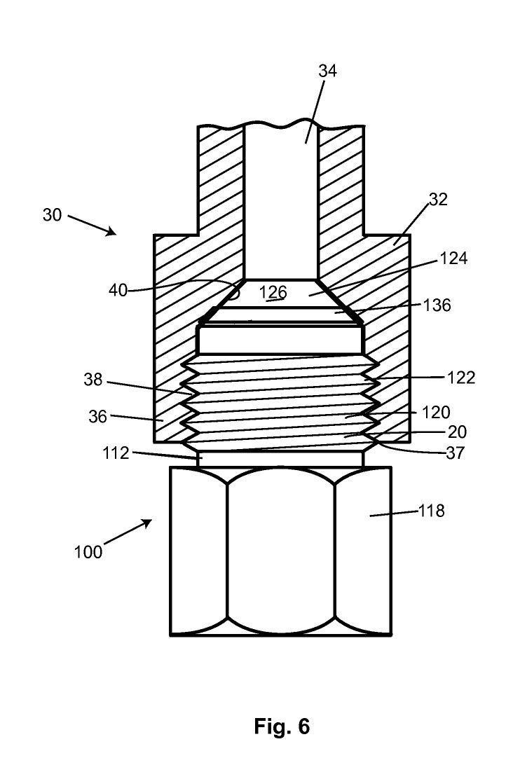

With reference to FIG. 6, in function, the annular seal 136, being slightly raised beyond the sealing surface 126 (shown exaggerated in FIG. 6 for ease of visualization) will engage an interior frusto-conical sealing surface (such as 40 for example) of a complementary female fitting 30 before the exterior frusto-conical sealing surface 126 engages. And as a result of the annular seal 136 being of a more malleable material than the remainder of the nose portion 124, it will deform to closely conform to the interior sealing surface 40 as the two fittings 100 and 30 are further tightened against each other—during the tightening of the coupling—(as a result of the clamping force generated by the threaded portions) to provide a secure, fluid-tight seal between the two fittings that is significantly less prone to leaking and which effectively resists the high fluid pressures typically used in high pressure hydraulic systems.

Elastomeric O-ring seals as used in some low pressure hydraulic fittings in the prior art are not suitable because the high fluid pressures (typically from 2,000 psi-10,000 psi) will cause the fluid to readily by-pass such elastomeric O-ring type seals, resulting in leaks.

While a high pressure hydraulic fitting is illustrated and described herein having an annular seal 136 embedded or formed within a groove 130 on an exterior (male) frusto-conical sealing surface 126 of the fitting, in other embodiments of the present invention, an annular seal analogous to annular seal 136 could be embedded or formed into an interior (female) frusto-conical sealing surface of a female fitting, and such fitting could be coupled to a prior art fitting having a conventional frusto-conical nose portion (such as for example nose portion 26 of fitting 10).

Advantageously, the present invention may be utilized within the envelope dimensions of standard hydraulic fittings, and therefore no other changes to the other components in the high pressure hydraulic system are required.

While specific embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. A hydraulic fitting for use in hose couplings in high pressure hydraulic systems, the fitting comprising:
a body comprised of a hard material and having an externally threaded portion that terminates in a frusto-conical nose portion having a frusto-conical sealing surface;
a circumferential groove provided in the sealing surface; and
an annular seal received in the groove and comprised of a more malleable material than said hard material, wherein a portion of the annular seal extends beyond the sealing surface such that the annular seal is able to deform upon tightening of the coupling to closely conform to an internal frusto-conical sealing surface of a complementary fitting used in the coupling to provide a fluid-tight seal between the fittings.

2. The device of claim 1, wherein the annular seal is comprised of a metal or plastic having the following properties: hardness of less than Rockwell R125 (Rockwell F 40); tensile strength less than 10,000 psi; temperature stability such that it is dimensionally stable below 60° C.; corrosion resistance such that it is resistant to corrosion in moist atmosphere, and is resistant to mechanical property changes in sunlight, atmospheric moisture, and hydraulic oil.

3. The device of claim 1, wherein the annular seal is comprised of a plastic having the following properties: hardness in the range of Rockwell R78-R120; tensile strength in the range 8,000 psi-10,000 psi; temperature stability such that it is dimensionally stable below 60° C.; corrosion resistance such that it is resistant to mechanical property changes in sunlight, atmospheric moisture, and hydraulic oil.

4. The device of claim 1, wherein the annular seal is comprised of a plastic having the following properties: hardness in the range of Rockwell R90-R100; tensile strength in the range 9,000 psi-10,000 psi at 23° C.; temperature stability such that it is dimensionally stable below 60° C.; corrosion resistance such that it is resistant to mechanical property changes in sunlight, atmospheric moisture, and hydraulic oil.

5. The device of any one of claims 1 to 4, wherein the annular seal includes a frusto-conical exterior surface that is parallel to the sealing surface of the nose portion.

6. The device of claim 5 wherein the exterior surface of the annular seal is above the sealing surface of the nose portion by an amount in the range 0.06 mm to 0.25 mm.

7. The device of claim 3, wherein the annular seal comprises an acetal resin plastic.

8. The device of claim 7, wherein the annular seal comprises polyoxymethylene.

9. The device of claim 8, wherein the annular seal comprises DELRIN (trademark).

10. The device of claim 3, wherein the annular seal comprises polytetrafluoroethylene.

11. The device of claim 2, wherein said hard material comprises steel or stainless steel, and the annular seal comprises copper.

12. A method of establishing a fluid impermeable seal in hose couplings in high pressure hydraulic systems between mating male and female frusto-conical sealing surfaces, composed of a hard material, to prevent hydraulic fluid from leaking out of said coupling, the method comprising the steps of:
a) providing a circumferential groove in one of said frusto-conical sealing surfaces; and
b) providing an annular seal in the groove, the annular seal being comprised of a metal or plastic having the following properties: hardness of less than Rockwell R125 (Rockwell F 40); tensile strength less than 10,000 psi; temperature stability such that it is dimensionally stable below 60° C.; corrosion resistance such that it is resistant to corrosion in moist atmosphere, and is resistant to mechanical property changes in sunlight, atmospheric moisture, and hydraulic oil, wherein a portion of the annular seal extends above said one of said frusto-conical sealing surfaces such that the annular seal is able to deform upon tightening of the coupling to closely conform to the other of said frusto-conical sealing surfaces to provide a fluid-tight seal between said frusto-conical sealing surfaces.

13. The method of claim 12, further including the step of providing a frusto-conical exterior surface in the annular seal that is parallel to said one of said frusto-conical sealing surfaces.

14. The method of claim 13 wherein the exterior surface of the annular seal is above said one of said frusto-conical sealing surfaces by an amount in the range 0.06 mm to 0.26 mm.

15. The method of claim 14, wherein the annular seal comprises an acetal resin plastic.

16. The method of claim 15, wherein the annular seal comprises polyoxymethylene.

17. The method of claim 16, wherein the annular seal comprises DELRIN (trademark).

18. The method of claim 14, wherein the annular seal comprises polytetrafluoroethylene.

19. The method of claim 14, wherein said hard material comprises steel or stainless steel, and the annular seal comprises copper.
